(19) United States
(12) Patent Application Publication
(10) Pub. No.: US 2026/0342024 A1
(43) Pub. Date: Oct. 29, 2026

(54) System and Method for Real-Time Monitoring of the Plug Attachment Status of Telecommunication Ports in a Network

(71) Applicant: James L. Kraft, Middletown, PA (US)

(72) Inventor: James L. Kraft, Middletown, PA (US)

(21) Appl. No.: 19/658,563

(22) Filed: Apr. 26, 2026

Related U.S. Application Data
(60) Provisional application No. 63/795,987, filed on Apr. 28, 2025.

(51) Int. Cl. H01R 13/717; H01R 13/66

(52) U.S. Cl. CPC H01R 13/7172; H01R 13/665

(57) ABSTRACT

A port attachment monitoring system monitors whether a plug is plugged into a port of a telecommunications network. The port attachment monitoring system includes a light emitter circuit and a light detector circuit placed along an insertion path of the port. The emitter and detector circuits are aligned along the plug insertion path of the port. When a plug is plugged into the port, the system generates a first data signal representing that a plug is plugged into the port. When a plug is not plugged into the port, the system generates a second data signal representing that a plug is not plugged into the port. Monitoring the data signal detects whether a plug has been plugged into the port or a plug has been unplugged from the port, and whether or not a plug is currently plugged into the port.

### RELATED APPLICATION

This application claims priority to and the benefit of my provisional patent application Ser. No. 63/795,987 “Preferred Method of Monitoring a Data Patch Cable at the Patch Panel and/or Switch Port End” filed Apr. 28, 2025 at Attorney Docket No. 1-3566-P, which priority application is incorporated by reference as if fully set forth herein.

### FIELD OF THE DISCLOSURE

This disclosure relates to network management systems, and in particular, to a system and related method that provides real-time monitoring of the plug attachment status of telecommunication ports in the network.

### BACKGROUND OF THE DISCLOSURE

A patch cable or patch cord is an electrical or fiber-optic cable formed from an appropriate material that includes a plug on one end that removably plugs the cable to a compatible port of a device (such as a patch panel, switch panel, wall jack, or the like, such device referred to generically herein as a “jack panel”) for routing telecommunications to and from the port through the patch cable. A patch cable may have plugs on both ends to connect the port of one jack panel with another port of the jack panel or with the port of another jack panel.

An example of a patch cable is an Ethernet cable having RJ 45 connectors as plugs on both ends of the patch cable. Another example of a patch cable is a USB cable having different plugs on the ends of the cable—a USB Type C plug on one end and a USB Type A plug on the other end.

A single-ended patch cable has only one plug on one end of the patch cable. The single-ended patch cable may extend from a portable device for example and enables the device to connect to a jack panel. A two-ended patch cable has a plug on each end of the cable. A two-ended patch cable can connect jack panels of different devices (for example, a switch and a computer, a switch and a router, two spaced apart patch panels, or the like).

When managing telecommunication connections, it has become increasingly important to know when patch cables are plugged in or disconnected, which ports of which jack panels the patch cables are plugged into, and if the plug of a patch cable has been moved from one port to another port.

For example, a port of a jack panel can be assigned to connect to a specific type of device and to provide a specific type of functionality. A port that is configured for a wireless access point only will not enable a PC plugged into that port to work. An individual PC can be configured to only work on ports that are configured for use with such PCs.

Limiting connectivity of jack panel ports can be motivated by many reasons, including performance and security. If someone mistakenly moves one patch cable to a different location it can make it almost impossible to know where that patch cable was moved, possibly creating unacceptable downtime for multiple users and, in the case of data centers, may affect thousands if not millions of users.

Thus there is a need to for a port monitoring system that monitors the port to detect when a patch cable has been plugged into the port of a jack panel, when a patch cable has been unplugged from the port of a jack panel, and to report and record these events for event history and security purposes.

### SUMMARY OF THE DISCLOSURE

Disclosed is a port monitoring system that embodies a method of monitoring the port attachment status of a port to monitor when a plug has been plugged into a specific port of a jack panel, when a plug has been unplugged from a specific port of a jack panel, and to report and record the plug attachment events for event history and security purposes.

A port monitoring system in accordance with this disclosure is relatively inexpensive and can be adapted for use with conventional patch cables and jack panels.

An embodiment of the port monitoring system uses a light emitter (“emitter”) and a light detector (“detector”) associated with a specific port of a jack panel. The emitter and the detector are positioned outside of the port along the insertion path followed by a plug being plugged into the port.

The emitter and detector may work using infrared light, visible light, laser light, or other types and frequencies of electromagnetic radiation. The system designer can choose the appropriate type of emitter and detector for the working environment of use. It is believed that for most environments the disclosed port monitoring system can utilize infrared emitters and detectors so that the emitted light is invisible to the eye and resists detector interference from visible light sources.

In one embodiment, the emitter and the detector are located on opposite sides of the insertion path. The emitter is aligned with the detector to illuminate the detector when no plug is plugged into the port. The detector when being illuminated generates a signal representing that no plug is plugged into the port. The plug substantially blocks the detector from the emitter when a plug is plugged into the port. The detector when substantially blocked from the emitter generates a data signal representing that a plug is plugged into the port.

In another embodiment, the emitter and the detector are located on the same side of the insertion path. The emitter is aligned with the detector to not substantially illuminate the detector when a plug is not plugged into the port. The detector when not substantially illuminated generates a signal representing that no plug is plugged into the port. The plug reflects light from the emitter to the detector when a plug is plugged into the port, thereby substantially illuminating the detector. The detector when substantially illuminated generates a data signal representing that a plug is plugged into the port.

The detector signal is transmitted from the detector to a port event monitoring system. The port event monitoring system continuously monitors the detector signal for the plug attachment state of the port-whether the port is an active state with a plug being plugged into the port, or whether the port is in a passive state without a plug being plugged into the port. When the monitoring system detects a change in the state of the port, the monitoring system issues a port status change event that results in the change of attachment status of the port and the time of the event to be stored in a database or to a data appliance. The monitoring system can also use other available data such as the identity of a user associated with the port to link the state change event as affecting the user. The monitoring system can also respond to requests for the current state of the port.

The emitter and the detector may each be a component of a printed circuit board connectable to a power supply that powers the component. The detector printed circuit board can be connected to the monitoring system for transmitting the detector signal to the monitoring system.

Jack panels may have side-by-side sets or rows of two or more ports. The printed circuit boards can extend along the rows and carry multiple emitters and/or detectors needed to monitor the set of ports. The printed circuit boards may include a power bus connected to the power supply to power the components on the printed circuit boards, and may include a data bus that receives the detector signals and transmits the data signals to the monitoring system.

The identity of a port may be encoded in the light emitted by the emitter to be imprinted in the data signal and used by the monitoring system to identify the port associated with the data signal. Alternatively, the monitoring system is programmable to associate each data signal received into the monitoring system with a respective port.

The disclosed port monitoring system enables the use of off the shelf patch cables and jack panels. Proprietary or non-standard patch cables or jack panels need not be used for the port monitoring system to function properly.

The port monitoring system can utilize custom circuit boards that can be attached to a jack panel to position and align multiple emitters and detectors with multiple ports of the jack panel. Circuit boards carrying multiple emitters and/or detectors can be provided with a power bus that transfers power from a power source to the emitters and/or detectors. Circuit boards carrying multiple detectors can be provided with a data bus connectable to the monitoring system that carry the data signals from the detectors to the monitoring system. The database can include a multiplexer that combines multiple data signals into a single composite signal sent to the monitoring system.

The monitoring system can demodulate composite signals, analyze the data signals, detect changes in the port attachment states of the ports being monitored by the system, and transport that information to an application server or other data appliance for event analysis, storage, generating alerts, and other uses important to the enterprise. For example, a network administrator can receive a message in real time whenever a port changes its port attachment state. If someone at a remote location moves a patch cable from jack panel port 3 to jack panel port 15 and such a move was not authorized or was made in error, the administrator can quickly identify and rectify the situation. Network downtime and user inconvenience is reduced.

The disclosed port monitoring systems also enables administrators to know if unused ports are available generally within a system or available on specific jack panels of the system. Monitoring the unused port capacity of a system can alert the administrators that it is time to expand the port capacity of the system.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 illustrates a first embodiment port monitoring system in accordance with this disclosure,

FIG. 2 is similar to FIG. 1 but illustrates the port monitoring system in which the port has a plug plugged into it.

FIGS. 3-6 illustrate two of the port monitoring systems monitoring the port attachment states of two ports with respect to a two-ended patch cable that can connect the two ports.

FIG. 7 is a schematic view of a second embodiment port monitoring system in accordance with this disclosure.

FIG. 8 is a schematic view of a third embodiment port monitoring system in accordance with this disclosure.

FIG. 9 is a schematic view of a fourth embodiment port monitoring system in accordance with this disclosure.

FIG. 10 is a schematic view of a fifth embodiment port monitoring system in accordance with this disclosure.

FIG. 11 illustrates the port monitoring system shown in FIG. 10 operating to detect a plug plugged into a port being monitored by the system.

FIG. 12 is a schematic view of a sixth embodiment port monitoring system in accordance with this disclosure.

FIG. 13 is a schematic view of a seventh embodiment port monitoring system in accordance with this disclosure.

FIGS. 14-16 illustrates the port monitoring system shown in FIG. 13 operating to detect plugs plugged into the two ports being monitored by the system.

FIG. 17 is a schematic view of an eighth embodiment port monitoring system in accordance with this disclosure.

FIG. 18 is a schematic view of a ninth embodiment port monitoring system in accordance with this disclosure.

### DETAILED DESCRIPTION

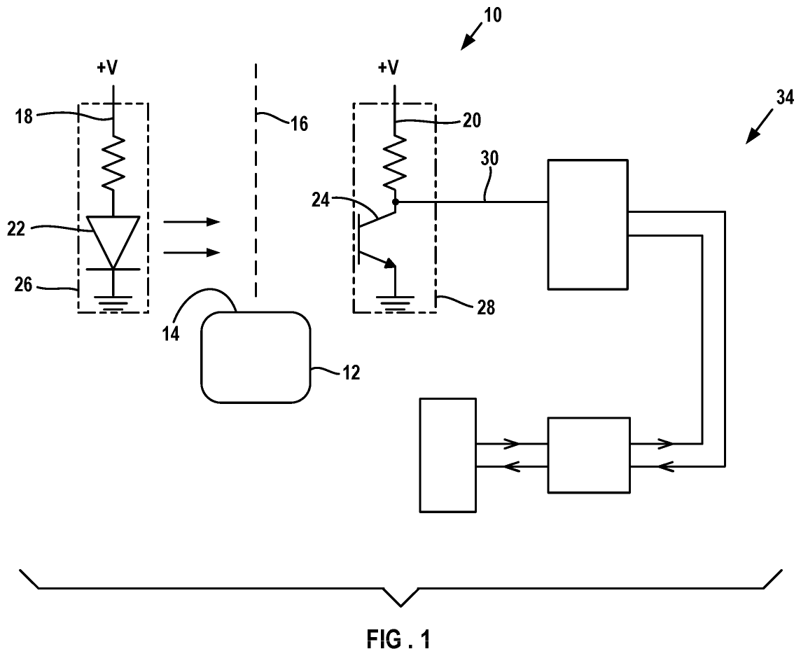

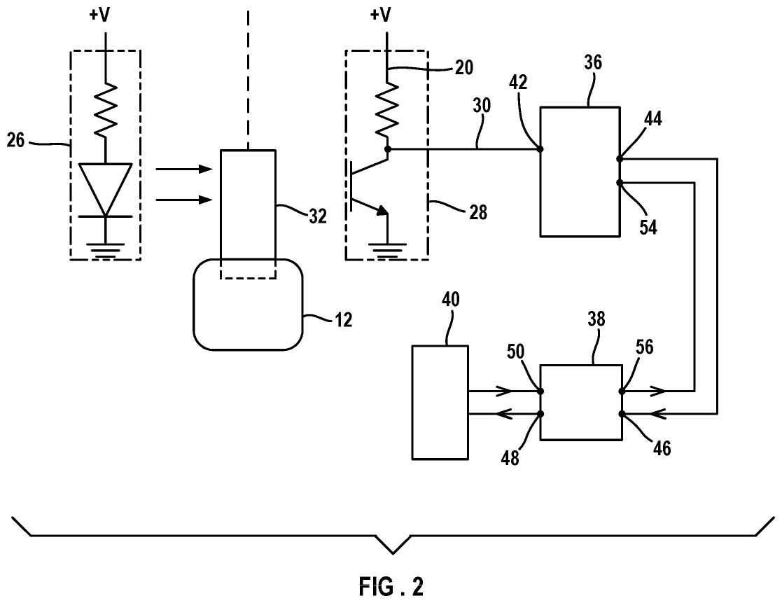

FIGS. 1 and 2 illustrate a first embodiment port monitoring system 10 in accordance with this disclosure. The port monitoring system monitors the port attachment state of a port 12 of a jack panel (not shown). The port has a front plug attachment side 14 that receives a plug of a patch cable (not shown) to form electrical or optical connections between the patch cable and the plug. The plug follows along an insertion path 16 aligned with the front plug attachment side when plugging the plug into the port. The plug follows along the same insertion path when being unplugged from the port.

The port monitoring system 10 includes a light emitter circuit 18 and a light detector circuit 20. The light emitter circuit 18 and the light detector circuit 20 are located on opposite sides of the insertion path 16. The space between the light emitter circuit and the light detector circuit is sufficient to allow a user to use a compatible plug of the patch cable with the port 14.

The light emitter circuit includes a light emitter 22 (referred to as an “emitter” herein) that is designed to emit infrared (IR) light. The light detector circuit includes a light detector 24 (referred to as a “detector” herein) that is designed to detect the presence of infrared light illuminating the detector. The detector is aligned with the emitter whereby the detector detects the light emitted by the emitter when the space between the detector and the emitter is not obstructed.

The resistance and output voltage of the illustrated detector 24 changes in proportion to the intensity of the IR light illuminating the detector. Different detectors may utilize different voltage, current, or signal strategies of signaling the intensity of light illuminating the detector.

The light emitter circuit 18 is realized as a printed circuit board 26. The emitter PCB 26 includes the emitter 22 and the related circuitry to power the emitter when connected to a power source +V. The light detector circuit 20 is realized as a printed circuit board 28. The detector PCB 28 includes the detector 24 and the related circuitry to power the detector when connected to a power source +V.

The port monitoring system 10 includes a detector signal line 30 connected to and extending away from the detector PCB 28. The signal line is operatively connected to the detector 24. When the detector is being illuminated, the signal line 30 is at a higher voltage. The higher voltage is a signal representing the detector is being illuminated by the emitter 22. When the detector is not being illuminated, the signal line 30 is at a lower voltage. The lower voltage is a signal representing the detector is not being illuminated by the emitter.

In FIG. 1 the gap between the emitter 22 and the detector 24 is unobstructed. The detector is being substantially illuminated by the emitter. The signal line 30 is in its higher voltage state, signaling that a plug is not plugged into the port 12. The port has a port attachment status of “no plug is plugged into the port”.

In FIG. 2 the gap between the emitter 22 and the detector 24 is obstructed by a plug 32 connected to the port 12. The plug prevents substantial illumination of the detector by the emitter. The signal line 30 is in its lower voltage state, signaling that a plug is plugged into the port 1. The port has a port attachment status of “a plug is plugged into the port”.

In the illustrated embodiment a port event monitoring system 34 continuously monitors the port monitoring system 10 via the detector signal line 30. The illustrated port event monitoring system includes a microcontroller 36, a transceiver 38, and a network connector 40. The transceiver handles communications between the microprocessor and the network connector. The network connector connects the transceiver to a network (not shown) for communication between the port event monitoring system and interested devices connected to the network.

The network may be a serial network, an Ethernet network, a process control network such as an APL network or a fieldbus network, or some other type of wired or wireless communications network. Other alternative networking technologies or architectures can be used for monitoring the port monitoring system.

The microcontroller 36 has an input terminal 42. The input terminal receives the detector data signal into the microcontroller. The microcontroller associates the input terminal with a specific port (here, the port 12) by being programmed to associate the input terminal with a specific port ID or number. Alternatively, the data signal being received into the input terminal encodes the identity of the port (for example, by binary encoding of the port number) and the microcontroller decodes the signal to determine the port identity (similar to how a conventional television remote control and a television receiver respond to commands encoded in infrared transmissions from the remote control). The microcontroller then stores the port identity and its associated input terminal in local memory.

It is contemplated the microcontroller 36 will typically have a number of input terminals, each connected to a signal line of a respective detector that is monitoring a respective port. The microcontroller continuously polls the input terminals to detect changes in the plug attachment status of the ports operatively connected to the microcontroller through the signal lines. Possible embodiments of the port event monitoring system 34 include multiple microcontrollers that can be distributed throughout a location or geographical area and form a distributed port event monitoring system.

If the microcontroller 36 detects for example a change in attachment status of the signal line of the detector 24 associated with the port 12, the microcontroller generates a port status change event that is transmitted to the network. Data defining a port status change event typically includes the port ID, the changed attachment status of the port (plugged in or not plugged in) and the time/date of the event.

The microcontroller transmits the port status change event data via a microcontroller Transmit terminal 44 to a Receive terminal 46 on the microcontroller side of the transceiver 38.

The transceiver 38 receives the status change event and converts the data of the status change event into a format compatible with the network. The transceiver then transmits the network-formatted data through a Transmit terminal 48 on the network side of the transceiver to the network connector 40 that injects the network-formatted data into the network. The illustrated transceiver is designed for a wired network connector, but a transceiver may be used that connects with a wireless network connector instead.

Event handling is a conventional mechanism used in network software architecture that allows generating actions responsive to specific events. Many books and articles are available on event handling so handling of the status change event outside of the port event monitoring system 34 will not be discussed in further detail.

The illustrated port event monitoring system 34 can also receive queries from the network requesting the status of the port 12. The microcontroller 36 is provided with a network address for receipt of such queries. The query is received from the network through the network connector 40 and is transmitted to a transceiver Receive terminal 50 on the network connector side of the transceiver 38. The transceiver converts the query into a format compatible with the microcontroller. The microcontroller receives the query through a microcontroller Receive terminal 54 connected to the transceiver Transmit terminal 56 on the microcontroller side of the transceiver.

In handling the query for a port status the microcontroller determines the appropriate I/O terminal to read and obtains the attachment status of the port. A port status message is created by the microcontroller representing the attachment status of the queried port. The port status message typically includes the identity of the port, the attachment status of the port, and the time/date the port status message was created. The port status message is transmitted to the network through the transceiver 36 in the same manner as a port status change event.

The network can communicate port status messages and port status change events to a dedicated notification appliance such as the Squidlite Snapp (TM) notification appliance invented by the inventor herein, but it should be understood that this information could go to any network management device, appliance, database, microservice, or software program.

FIGS. 3-6 illustrate a double-ended patch cable 58 having a first plug 60 on one end of the cable and a second plug 62 on the other end of the cable. The figures illustrate different port attachment states of the first port 12 and a second port 64 being connected by the patch cable. The ports may be common ports of a jack panel or may be on different jack panels. The port attachment status of the port 12 is monitored by the port monitoring system 10. The port attachment status of the port 64 is monitored by a like second port monitoring system 66. The two signal data lines of the port monitoring systems are connected to respective different input terminals of the microcontroller 36 of the port event monitoring system 34.

FIG. 3 illustrates the patch cable 58 having its first plug 60 not being plugged into the first port 12 and its second plug 62 being plugged into the second port 64. The first plug 60 does not obstruct illumination of the detector of the first port monitoring system 10. In this state, the data signal line of the first port monitoring signals the microcontroller no plug is plugged into the first port 12. The second plug substantially obstructs illumination of the detector of the second port monitoring system 66. The data signal line of the second port monitoring system signals the microcontroller that a plug is plugged into the port 62.

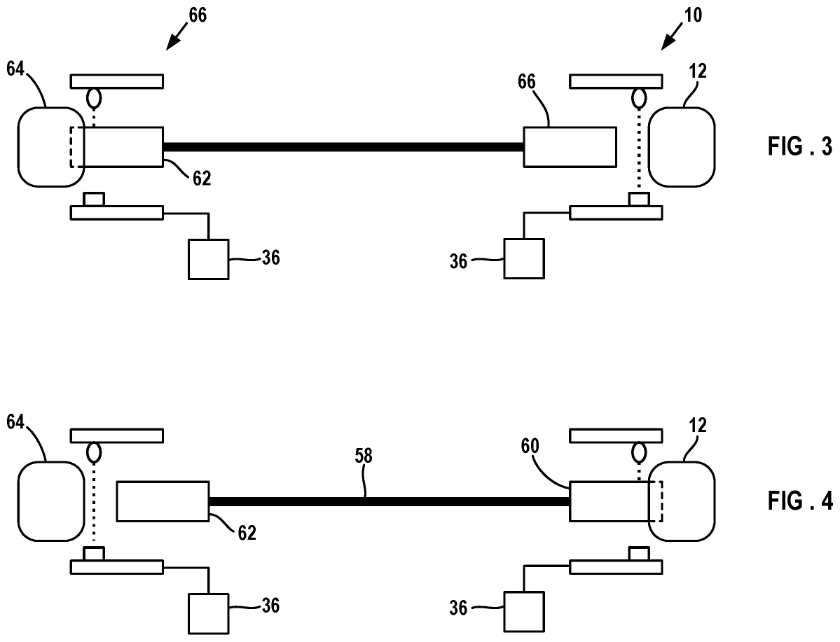

FIG. 4 illustrates the patch cable 58 having its first plug 60 being plugged into the first port 12 and the second plug 62 being unplugged from the second port 64. The first plug 60 substantially obstructs illumination of the detector of the first port monitoring system 10. In this state, the data signal line of the first port monitoring system signals a plug is plugged into the port 10. The second plug does not obstruct illumination of the detector of the second port monitoring system 66. The data signal line of the second port monitoring system signals a plug is not plugged into the second port 62.

Going from the patch cable connections shown in FIG. 3 to those shown in FIG. 4 generates port status change events that are transmitted through the network for event storage, analysis, or other handling. Plugging the first plug 60 into the first port 12 generates a port status change event associated with the first port. Unplugging the second plug 62 from the second port 64 generates a port status change event associated with the second port.

FIG. 5 illustrates the patch cable 58 having its first plug 60 being unplugged from the first port 12 and the second plug 62 being unplugged from the second port 64. The data signal line of the first port monitoring system signals a plug is not plugged into the port 10. The data signal line of the second port monitoring system signals a plug is not plugged into the second port.

Going from the patch cable connections shown in FIG. 4 to those shown in FIG. 5 generates a port status change event associated with the first port 12 caused by unplugging the first plug 62 from the first port.

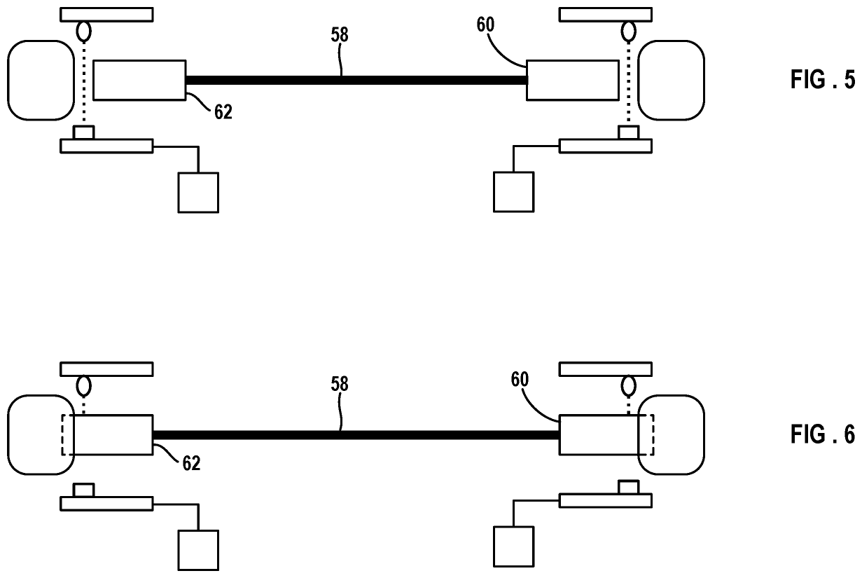

FIG. 6 illustrates the patch cable 58 having its first plug 60 plugged into the first port 12 and the second plug 62 being plugged into the second port 64. The data signal line of the first port monitoring system signals a plug is plugged into the first port. The data signal line of the second port monitoring system signals a plug is plugged into the second port.

Going from the patch cable connections shown in FIG. 5 to those shown in FIG. 6 generates port status change events. Plugging the first plug 60 into the first port 12 generates a port status change event associated with the first port. Plugging the second plug 62 into the second port 64 generates a port status change event associated with the second port.

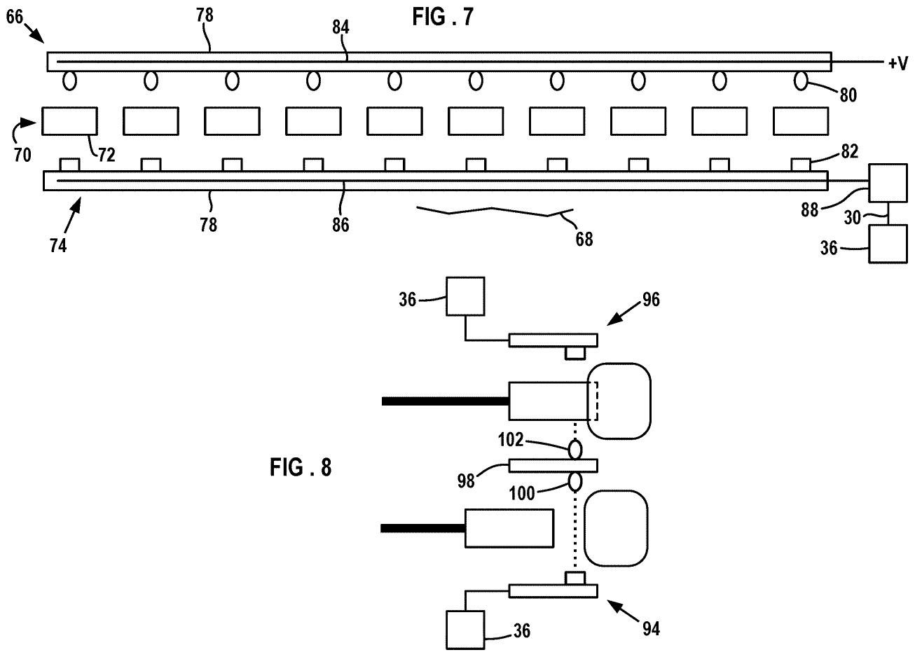

Jack panels are often provided with a number of ports arranged side-by-side in a row. FIG. 7 illustrates a jack panel 68 having a single row 70 of ten side-by-side like ports 72. A second embodiment port monitoring system formed as a row port monitoring system 74 simultaneously monitors the plug attachment states of the ten ports of the row.

The row port monitoring system 74 includes a multi-emitter printed circuit board 76 and a multi-detector printed circuit board 78. The multi-emitter PCB includes ten light emitter electrical circuits that space ten emitters 80 along the length of its board. The multi-detector PCB includes ten light detector electrical circuits that space ten detectors 82 along the length of its board. The two boards are attached to the jack panel 68 on opposite sides of and parallel with the row 70 of ports. The emitters and detectors are arranged so that respective emitter/detector pairs face each other and monitor the insertion path of an individual jack in the row. Each facing emitter/detector pair operates like an individual port monitoring system 10 for its associated port as previously discussed.

The multi-emitter PCB 76 includes a power bus 84 that receives external power +V and distributes the power to the light emitter circuits. The multi-detector PCB 78 includes a data bus 86 that receives the individual port signals from the detectors. The illustrated data bus includes a multiplexer 88 aggregating the detector data signals into a single composite signal transmitted to the microprocessor 36. The microprocessor de-modulates the composite signal into its individual signal components. The multi-detector PCB also includes a power bus (not shown) that receives external power and distributes the power to the light detector electrical circuits.

FIG. 8 illustrates a first port 90 and a second, adjacent port 92. The first port is monitored by a first port monitoring system 94. The second port is monitored by a second port monitoring system 96. The first and second monitoring systems monitor their respective port in the same manner as an individual port monitoring system 10. The arrangement of the ports however enable the first and second monitoring system to share in common a printed circuit board 98 that forms a part of a third embodiment port monitoring system that simultaneously monitors both parts. The common printed circuit board 98 is disposed between the two ports and carries components for each of the first and second port monitoring systems. In the illustrated embodiment the shared PCB 98 includes the emitters 100, 102 of the first port monitoring system 94 and the second port monitoring system 96 respectively.

Alternatively, the common PCB 98 carries the detectors of the monitoring systems. In another possible embodiment, the common PCB carries the detector for one of the port monitoring systems and the emitter for the other port monitoring system.

Jack panels are often provided with multiple “stacked” rows of aligned ports, each row typically vertically spaced apart from adjacent rows.

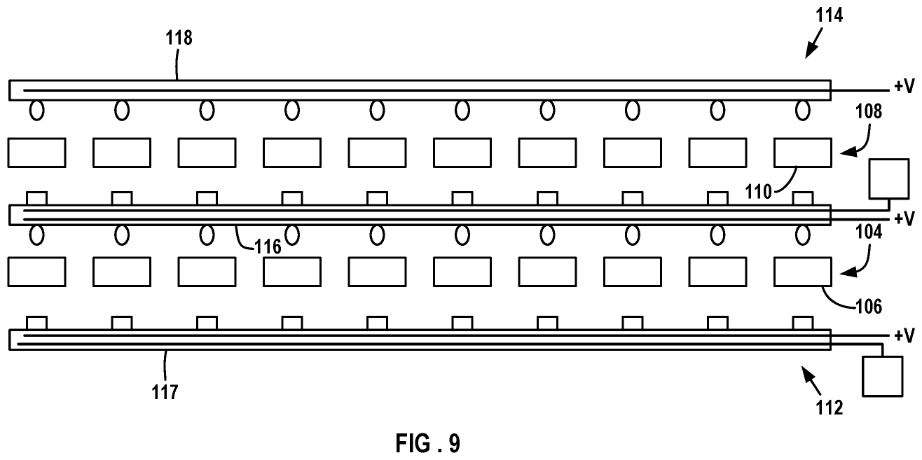

FIG. 9 illustrates a jack panel having a first row 104 of ten ports 106 and a second row 108 of ten ports 110, the rows in a stacked arrangement. The ports of the first row are monitored by a first row port monitoring system 112 and the ports of the second row are monitored by a second row port monitoring system 114. The two monitoring systems in combination define a fourth embodiment port monitoring system that simultaneously monitors the port attachment states of the ports in both rows of ports.

Like the port monitoring system 74 shown in FIG. 7, the printed circuit boards of the two monitoring systems 112, 114 extend along the row of ports associated with the port monitoring system. Like the port monitoring system in FIG. 8, a printed circuit board disposed between a pair of stacked rows carry components for the monitoring systems for the ports on opposite sides of the printed circuit board. In FIG. 8, the printed circuit board 116 is disposed between the first row 104 and the second row 106. The printed circuit board 116 is a common printed circuit board for both row port monitoring systems 112, 114. The illustrated common PCB 116 carries the emitters for the first row port monitoring system 112 and the detectors for the second row port monitoring system 114. The common PCB also carries a power bus for powering the PCB and a data bus for transmitting detector signals to the microprocessor. The printed circuit boards that extend along only one row and not between rows carry only emitter or detectors for the row port monitoring system associated with the one row. The PCB 117 that extends only along the first row 104 carries the detectors of the first row port monitoring system 112 and is similar to the PCB 78 shown in FIG. 7. The illustrated PCB 118 that extends only along the second row 108 carries the emitters for the second row port monitoring system 112 and is similar to the PCB 76 shown in FIG. 7.

In alternative embodiments, the components on the common PCB board 116 may only be light emitter circuits or light detectors circuits, or the sides of the common PCB board may have both types of circuits on each side, possibly alternating along the length of the side. The arrangement of light emitter circuits and light detector circuits enable emitters and detectors to properly face one another.

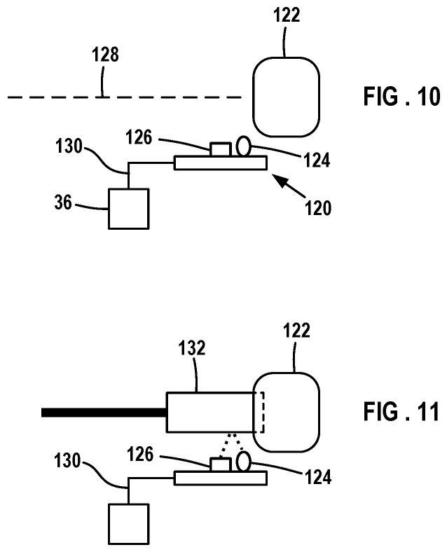

The previously described port monitoring systems place an emitter and detector monitoring the attachment status of a port on opposite sides of the insertion path of the port. FIG. 10 illustrates a fifth embodiment port monitoring system 120 monitoring the port attachment status of a port 122. The port monitoring system 120 includes an emitter 124 of a light emitter circuit and a detector 126 of a light detector circuit that are both located on the same side of the port insertion path 128. FIG. 10 illustrates the emitter being downstream along the insertion path from the detector, but the relative positions of the emitter and detector along the insertion path can be reversed in alternative embodiments.

FIG. 10 illustrates the port 122 without a plug being plugged into the plug. The emitter does not substantially illuminate the detector. The detector signal line 130 is in a low voltage state, now signaling for this embodiment port monitoring system that a plug is not plugged into the port 122.

FIG. 11 illustrates a plug 132 being plugged into the plug 122. The light emitted by the emitter 124 reflects off the plug and substantially illuminates the detector 126. The detector signal line 130 is in a higher voltage state, now signaling that a plug is plugged into the port.

As an alternative to using the mere presence of reflective light illuminating the detector to detect the presence of the plug, the reflected light from the emitter can be used to measure the distance between the detector and the plug. Timed pulsed signals are sent out by the emitter and the delay in receipt by the detector can enable the distance to the plug to be calculated and used to determine a plug is plugged into the port. Embodiments of the port monitoring circuit utilizing distance contain the circuit elements required to determine distance. Use of light reflected from an emitter off an object and received by the detector to determine the distance to the object is known in the detection art and so will not be described in further detail. The frequency of the light emitted by a light emitter and detected by a light detector should be selected to obtain the needed distance resolution for the port monitoring system (for example, laser light or LIDAR might be used instead of infra-red light).

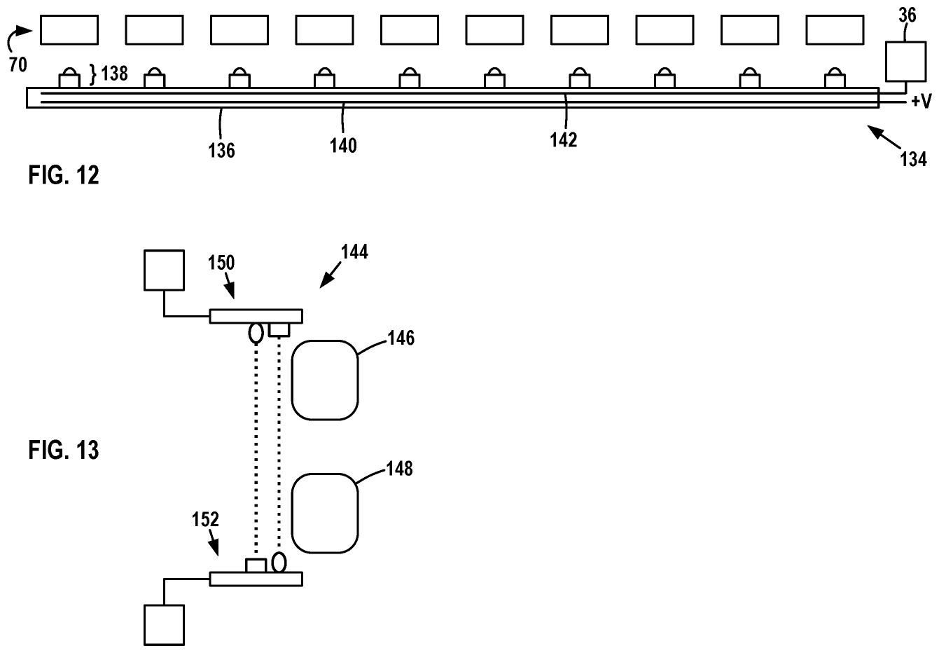

FIG. 12 illustrates a sixth embodiment port monitoring system 134 that simultaneously monitors the port attachment status of the row 70 of ten ports shown in FIG. 7. In this embodiment the port monitoring system includes a single printed circuit board 136 attached along one side of the row of ports. The single PCB mounts ten light detector circuit/light emitter circuit pairs 138, each pair arranged with respect to each other as shown in the port monitoring system of FIG. 10. The detector/emitter pairs are spaced along the single PCB to be located on the same side of the respective insertion paths of the ports. Each detector/sensor pair operates as a port monitoring system like the port monitoring system 120 shown in FIG. 10 for the pair's associated port. The single PCB board also includes a power bus 140 to power the components and a data bus 142 (the data bus multiplexer is omitted from the drawing) that transmits a composite data signal to the microprocessor 36.

The printed circuit board 136 includes detector/emitter pairs on one side of the board to monitor ports adjacent the one side. Other embodiments of the printed circuit board include detector/emitter pairs on the opposite side of the board as well, enabling simultaneous monitoring of port attachment status of the rows of ports on both sides of the board.

FIG. 13 illustrates a seventh embodiment port monitoring system 144 that functions as a two-port monitoring system that simultaneously monitors the port attachment status of side-by-side first port 146 and second port 148. The two-port monitoring system includes a first port monitoring system 150 that monitors the attachment status of the first port and a second port monitoring system 152 that monitors the attachment status of the second port. Each of the first and second port monitoring systems operates as a port monitoring system like the port monitoring system 120 shown in FIG. 10 that is disposed on one side of the insertion path of the port associated with the port monitoring system. The two ports 146, 148 are disposed between the two port monitoring systems 150, 152. The first port monitoring system is adjacent to the first port. The second port monitoring system is adjacent to the second port.

In FIG. 13 no plug is plugged into either the first port 146 or the second port 148. If a port monitoring system 150, 152 is monitoring port attachment status of its associated port by reflected light illuminating the detector, the distance of the detector from the emitter of the other port monitoring system is such that the voltage in the signal line is not sufficient to indicate a plug is plugged into the port. If the port monitoring system is monitoring port attachment status by determining distance, any measured distance would indicate no plug is plugged into the port. If both port monitoring systems are utilizing distance measuring, the timing of light emitted by the two emitters of the two-port monitoring system can be synchronized out of phase so that the individual operations of the port monitoring systems 150, 152 do not interfere with each other.

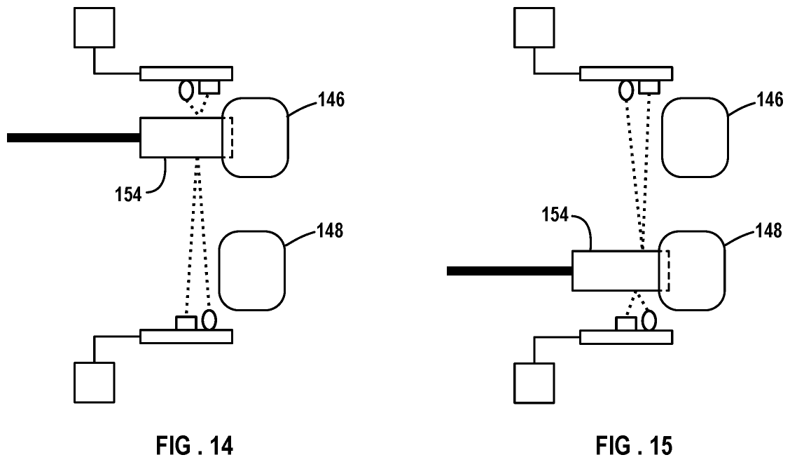

In FIG. 14, a plug 154 is plugged into the first port 146. The plug is substantially closer to the first port monitoring system 150 than the second port monitoring system 152. The detector voltage generated by the intensity of the reflected light now illuminating the detector of the first port monitoring system/distance measured to the plug 154 is now sufficient for the first port monitoring system to signal to the microcontroller 36 that a plug is present at the first port. The second port monitoring system does not receive sufficient intensity of reflected light/measured distance to plug 154 is not sufficient for the second port monitoring system to signal to the microcontroller that a plug is plugged into the second port 148.

FIG. 15 is similar to FIG. 14 but with the plug 154 plugged into the second port 148. The second port monitoring system 152 now signals to the microcontroller 36 that a plug is plugged into the second port. The first port monitoring system 150 signals to the microcontroller that no plug is plugged into the first port.

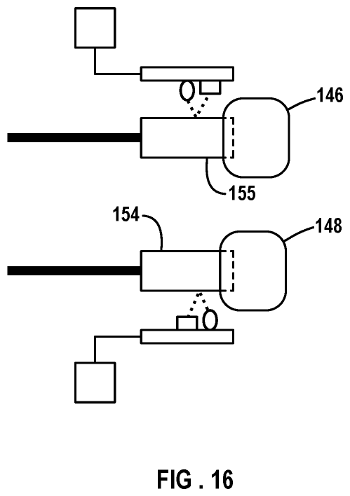

FIG. 16 is similar to FIG. 15 but now includes a plug 155 plugged into the first port. With plugs plugged into both ports, each of the port monitoring systems 150, 152 signal to the microcontroller 36 that a plug is plugged into its respective port.

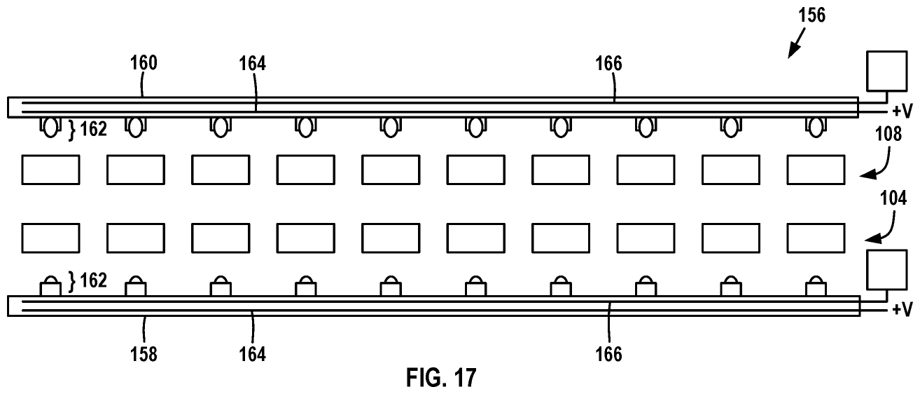

FIG. 17 illustrates the 20-jack jack panel shown in FIG. 9 but with the attachment status of the stacked rows 104, 106 of ports being monitored by an eighth embodiment port monitoring system 156 designed to simultaneously monitor a pair of stacked rows of ports. The port monitoring system includes a multi-emitter/detector printed circuit board 158 and a multi-emitter/detector printed circuit board 160. Each multi emitter/detector printed circuit board includes ten emitter/detector circuits like the emitter/detector circuit shown in FIG. 13 that are spaced apart along the length of the boards. The two boards are attached to the jack panel on opposite sides of and parallel with the two rows of ports. The emitter/detector pairs on the printed circuit boards are arranged to be aligned with respective pairs of ports of the rows so that respective emitter/detector pairs on the two boards face each other and monitor the attachment status of the two ports aligned with the pairs. Each facing emitter/detector pair operate like the two-port monitoring system 144 shown in FIG. 13.

Each printed circuit board 158, 160 includes a power bus 164 to power the printed circuit board from a power source +V and a data bus 166 (the multiplexer of the data bus is not shown) connected to the microcontroller 36.

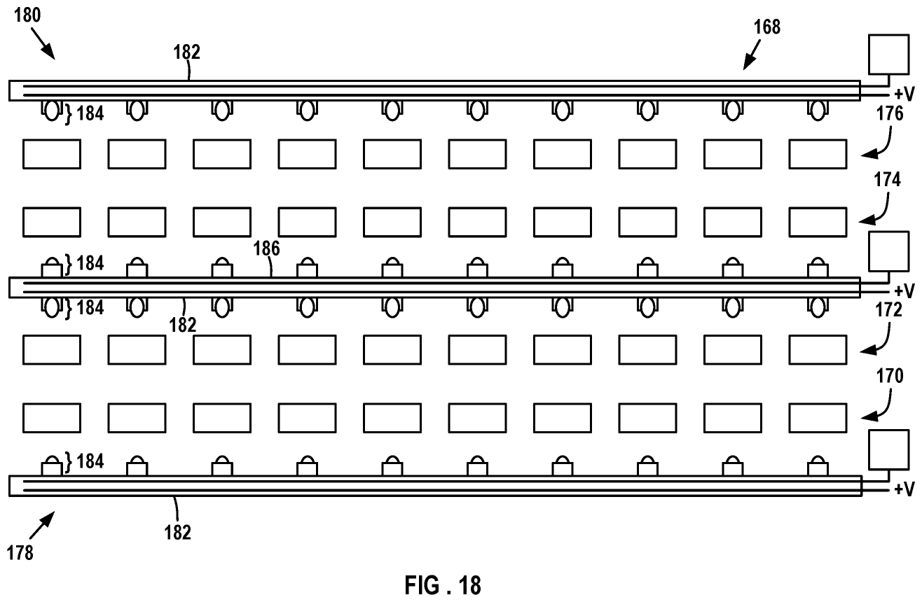

FIG. 18 illustrates a ninth embodiment port monitoring system 168 that simultaneously monitors of four stacked rows 170, 172, 174, 176, each row having ten ports. Each pair of adjacent rows are monitored by a multi-port monitoring system. The pair of stacked rows 170, 172 are monitored by a first multi-port port monitoring system 178. The pair of stacked rows 174, 176 are monitored by a second multi-port monitoring system 180.

Each of the first and second multi-port port monitoring systems operate like the multi-port port monitoring system 156 shown in FIG. 17. Each port monitoring system has multi emitter/detector printed circuit boards 182 attached to the jack panels that extend along opposite sides of the pair of stacked rows. The printed circuit boards have emitter/detector pairs 184 aligned with each other to monitor the pair of ports disposed between the emitter/detector pairs.

In this embodiment printed circuit boards 182 such as the printed circuit board 186 disposed between stacked pairs of rows is a common printed circuit board 182 for the port monitoring systems on opposite sides of the common printed circuit board. The illustrated common circuit board 186 carries emitter/detector pairs on one side for the port monitoring system 178 and carries emitter/detector pairs on the opposite side for the port monitoring system 180. The common printed circuit board 184 carries a power bus that powers the board and a data bus that transmits signals associated with the attachment status of the row of ports adjacent each of the opposite sides of the board. The printed circuit boards 182 that are not disposed between stacked pairs of rows are similar to the printed circuit boards shown in FIG. 17.

It should be understood that standard off the shelf patch cables and jack panels can be monitored by port monitoring systems in accordance with this disclosure. It is contemplated that printed circuit boards for port monitoring systems that simultaneously monitor a row or rows of ports can be manufactured to be compatible with industry standard or commonly used arrangements of ports and rows of ports found in commercially available jack panels.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including (but not limited to) changes in the number and configuration of ports monitored by a port monitoring system in accordance with this disclosure, the types of ports and plugs being monitored by the system, specific circuit designs and light frequencies used in performing plug detection, orientation and relative positioning of emitters and detectors with respect to each other and along port insertion paths, as well as such changes and alterations that fall within the purview of the following claims.

What is claimed is:

1. A method for monitoring the plug attachment status of a telecommunication port wherein a plug is pluggable and unpluggable from the port along an insertion path extending away from the port for making or breaking a telecommunications connection between the plug and the port, the method comprising the steps of:
(a) providing a light emitter circuit and a light detector circuit along the insertion path wherein the light emitter circuit and the light detector circuit are disposed so as to not obstruct plugging or unplugging the plug from the port, the light emitter circuit comprising an emitter that emits light and the light detector circuit comprising detector capable of sensing light illuminating the detector of a type emitted from the emitter, the light detector circuit being configured to generate and output a data signal based on the light being sensed by the detector;
(b) aligning the light emitter and the light detector with each other wherein:
when no plug is plugged into the port, the illumination of the detector by the emitter is such that the light detector circuit outputs a first data signal representing that a plug is not plugged into the port, and
when a plug is plugged into the port, the illumination of the detector by the emitter is such that the light detector circuit outputs a second data signal different from the first data signal, the second data signal representing that a plug is inserted into the port.

2. The method of claim 1 wherein step (a) comprises the step of:
(c) disposing the light emitter circuit and the light detector circuit on opposite sides of the insertion path wherein the emitter is aligned with the detector such that the emitter substantially illuminates the detector sufficient to generate the first data signal when there is no obstruction between the emitter and the detector whereby:
when no plug is plugged into the port there is no obstruction between the emitter and the detector enabling unobstructed illumination of the detector by the emitter whereby the first data signal is generated, and
when a plug is plugged into the port, the plug at least partially obstructing illumination of the detector by the emitter whereby the second data signal is generated.

3. The method of claim 2 wherein the data signal generated by the light detector circuit is a voltage, the voltage of the first data signal being greater than the voltage of the second data signal.

4. The method of claim 2 wherein the port is one of a plurality of ports, and the light emitter circuit and the light detector circuit are components of a port attachment status monitoring system being one of a plurality of like port attachment status monitoring systems, wherein:
step (a) comprises the step of:
disposing each port attachment status monitoring system of the plurality of port attachment status monitoring systems along an insertion path of a respective port of the plurality of ports with the light emitter circuit on one side of the insertion path of the port and the light detector circuit on the opposite side of the insertion path of the port; and
step (b) comprises the step of:
aligning each port attachment status monitoring system of the plurality of port attachment status monitoring systems with the respective port wherein each of the port attachment status monitoring systems operate wherein when no plug is inserted into the respective port the port attachment monitoring system generates a first data signal indicating no plug is plugged into the respective port and when a plug is plugged into the respective port the port attachment monitoring system generates a second data signal indicating a plug is plugged into the respective port.

5. The method of step 4 wherein some or all of the light emitter circuits of the plurality of port attachment status monitoring systems are on a first printed circuit board and some or all of the light detector circuits of the plurality of port attachment status monitoring systems are on a second printed circuit board, and step (a) comprises the step of:
(c) disposing the first printed circuit board on one side of the plurality of ports and disposing the second printed circuit board on the other side of the plurality of ports.

6. The method of step 5 wherein each printed circuit board of the first printed circuit board and the second printed circuit board comprise a power bus being configured to receive power from an external power source used to power the electrical circuits of the printed circuit board.

7. The method of claim 6 wherein each printed circuit board of the first printed circuit board and the second printed circuit board that has a plurality of detectors on the printed circuit board comprises a data bus being configured to receive the plurality of data signals output by the plurality of detectors on the printed circuit board to transmit the data signals along the data bus.

8. The method of claim 7 wherein each data bus comprises a multiplexer being configured to aggregate the plurality of data signals received by the data bus into a single composite signal.

9. The method of claim 8 comprising the steps of:
(d) receiving the composite signal from a multiplexer;
(e) decoding the composite signal and identifying each data signal making up the composite signal; and
(f) determining whether the data signal represents a change in the port attachment status of the port monitored by the detector generating the data signal, and if so, generating and transmitting a port status change event to a network.

10. The method of claim 5 wherein all of the light emitter circuits of the plurality of port attachment status monitoring systems are attached to the first printed circuit board and all of the light detector circuits of the plurality of port attachment status monitoring systems are attached to the second printed circuit board.

11. The method of claim 5 wherein the plurality of ports is a first plurality of ports and the first circuit board and the second circuit board are components of a first multi-port port status monitoring system;
step (a) comprises the step of
providing a second multi-port port status monitoring system like the first multi-port port status monitoring system and disposing the second multi-port port status monitoring system to monitor the port attachment status of a second plurality of ports, the second plurality of ports being disposed adjacent to the first plurality of ports wherein a printed circuit board being disposed between the first plurality of ports and the second plurality of ports is a common printed circuit board of both the first multi-port port status monitoring system and the second multi-port port status monitoring system.

12. The port monitoring system of claim 2 wherein the port is a first port, and the light emitter circuit and the light detector circuit are components of a first port attachment status monitoring system that monitors the first port;
step (a) comprises the steps of:
providing a second port attachment status monitoring system like the first port attachment status monitoring system, disposing the second port status monitoring system to monitor the port attachment status of a second port, the second ports being disposed adjacent to the first port wherein a printed circuit board being disposed between the first and second ports is a common printed circuit board of both the first and second port attachment monitoring systems, the common printed circuit board carrying the light emitter circuit or the light detector circuit of the first port attachment monitoring system on one side of the common printed circuit board and the light emitter circuit or the light detector circuit of the second port attachment monitoring system on an opposite side of the common printed circuit board.

13. The method of claim 1 wherein step (a) comprises the step of:
(c) disposing the light emitter circuit and the light detector circuit on the same side of the insertion path wherein the emitter does not directly illuminate the detector when there is no obstruction between the emitter and the detector whereby:
when no plug is plugged into the port, light emitted by the emitter does not directly illuminate the detector whereby the detector generates the first data signal, and
when a plug is plugged into the port, light from the emitter reflects off the plug and substantially illuminates the detector, the intensity of the reflected light at the detector sufficient for the detector to generate the second data signal.

14. The method of claim 13 wherein the data signal generated by the light detector circuit is a voltage, the voltage of the first data signal being less than the voltage of the second data signal.

15. The method of claim 13 wherein the second data signal represents a distance to the plug that indicates the plug is plugged into the port.

16. The method of claim 13 wherein the port is one of a plurality of ports, and the light emitter circuit and the light detector circuit form a first port attachment status monitoring system of a plurality of like port attachment status monitoring systems, wherein:
step (a) comprises the step of:
disposing each port attachment status monitoring system of the plurality of port attachment status monitoring systems along an insertion path of a respective port of the plurality of ports with the light emitter circuit and the light detector circuit on the same side of the insertion path of the port; and
step (b) comprises the step of:
aligning each port attachment status monitoring system of the plurality of port attachment status monitoring systems with the respective port wherein each of the port attachment status monitoring systems operate wherein when no plug is inserted into the respective port the port attachment monitoring system generates a first data signal indicating no plug is plugged into the respective port and when a plug is inserted into the respective port the port attachment monitoring system generates a second data signal indicating a plug is plugged into the respective port.

17. The method of claim 16 wherein the light emitter circuits and the light detector circuits of the plurality of like port attachment status monitoring systems are disposed on a printed circuit board.

18. The method of claim 17 wherein the printed circuit board comprises a power bus being configured to receive power from an external power source used to power components of the printed circuit board.

19. The method of claim 17 wherein the printed circuit board comprises a data bus being configured to receive the plurality of data signals output by the detectors of the plurality of port attachment status monitoring systems and to transmit the data signals along the data bus.

20. The method of claim 19 wherein the data bus comprises a multiplexer being configured to aggregate the plurality of data signals received by the data bus into a single composite signal.

21. The method of claim 17 wherein the plurality of light emitter circuits and the plurality of light detector circuits are components of a first multi-port port attachment monitoring system disposed on a first side of the printed circuit board, and the printed circuit board comprises a like second multi-port attachment monitoring system disposed on the opposite side of the printed circuit board wherein:
step (a) comprises disposing each port attachment status monitoring system of the plurality of port attachment status monitoring systems of the second multi-port port attachment monitoring system along an insertion path of a respective port of a second row of a plurality of ports; and
step (b) comprises the step of:
aligning each port attachment status monitoring system of the plurality of port attachment status monitoring systems of the second multi-port port attachment monitoring system with the respective port to monitor the port attachment status of the port.

22. The method of claim 13 wherein the port is a first port and the light emitter circuit and the light detector circuit are components of a first port attachment monitoring system disposed on one side of the first port insertion path, and:
step (a) comprises the step of disposing a second port attachment monitoring system like the first port monitoring system on one side of an insertion path of a second port in which the insertion paths of the first and second ports are disposed between the emitters and the detectors of the first and second port attachment monitoring systems.

23. The method of claim 22 wherein the first port is a port of a first row of a plurality of like ports and the second port is a port of a second row of a plurality of like ports, the first port attachment monitoring system being one of a plurality of like port attachment monitoring systems being disposed on a first printed circuit board, the second port attachment monitoring system being one of a plurality of like port attachment monitoring systems being disposed on a second printed circuit board, wherein:
step (a) comprises the step of placing the first printed circuit board on one side of the insertion paths of the plurality of ports of the first row of ports and placing the second printed circuit board on one side of the insertion paths of the plurality of ports wherein the insertion paths of the first row of ports and the insertion paths of the second row of ports are disposed between the first and second printed circuit boards; and
step (b) comprises the step of aligning each port attachment status monitoring system of the first plurality of port attachment status monitoring systems with a respective port of the first row of ports and aligning each port attachment status monitoring system of the second plurality of port attachment status monitoring systems with a respective port of the second row of ports wherein each of the port attachment status monitoring systems monitor the port attachment status of its respective port.

24. The method of claim 1 comprising the step of:
(c) receiving the data signal from the light detector circuit; and
(d) determining whether the data signal represents a change in the port attachment status of the port, and if so, generating and transmitting a port status change event to a network.

25. The method of claim 1 comprising the steps of:
receiving a query from the network requesting the port attachment status of the port;
determining the port attachment status of the port from the data signal generated by the light detector circuit; and
responding to the query with the determined port attachment status.
